(19) United States
(12) Patent Application Publication
(10) Pub. No.: US 2011/0106740 A1
(43) Pub. Date: May 5, 2011

(54) TISSUE CLASSIFICATION METHOD FOR DIAGNOSIS AND TREATMENT OF TUMORS

(75) Inventors: Timothy J. Yeatman, Tampa, FL (US); Greg Bloom, Tampa, FL (US)

(73) Assignee: University of South Florida, Tampa, FL (US)

(21) Appl. No.: 12/983,648

(22) Filed: Jan. 3, 2011

Related U.S. Application Data
(63) Continuation of application No. 10/446,610, filed on May 27, 2003, now abandoned.
(60) Provisional application No. 60/383,224, filed on May 24, 2002.
(60) Provisional application No. 60/389,071, filed on Jun. 14, 2002.

(51) Int. Cl. G06N 3/08

(52) U.S. Cl. 706/20

(57) ABSTRACT

The present invention discloses an informational computation method for classifying objects Specifically, the invention is a system, method, and computer-readable media for classifying tumors using a nonparametric statistical classifier in conjunction with an artificial neural network. The invention classifies unknown tumor types based on the correlation of unknown tumor's genetic expression compared to the genetic expression of know tumor types by first performing a nonparametric statistical analysis on the know data, training a artificial neural network with the known data, and then inputting the unknown tumor data into the neural network to calculate the probability that the sample tumor is a member of a class of tumors. By using a statistical classifier in conjunction with a neural network, the invention classifies unknown tumors more accurately then conventionally possible. Advantageously, by using a variety of tumor genetic expression data sets, including both published data sets and generated data sets, a tumor classifier, robust and accurate enough for clinical application, is provided.

### CROSS-REFERENCE TO RELATED APPLICATIONS

This application is a continuation of U.S. application Ser. No. 10/446,610, filed May 27, 2003, which claims the benefit of U.S. Provisional application Nos. 60/383,224 and 60/389,071, filed May 24, 2002 and Jun. 14, 2002, respectively, which are hereby incorporated by reference in their entirety

### GOVERNMENT SUPPORT

The subject invention was made with government support under a research project supported by the National Cancer Institute, Grant Number U01-CA8502-01A1.

### FIELD OF THE INVENTION

The present invention relates generally to an informational computation method for classifying objects, and, in particular, to a system, method, and computer-readable media for classifying tumors using a nonparametric statistical classifier in conjunction with an artificial neural network.

### DESCRIPTION OF THE RELATED ART

Accurate diagnosis of tumors is paramount to the optimal management of cancer patients because essentially all therapeutic decisions stem from tissue diagnosis. The introduction of gene expression profiling has resulted in the production of enormous datasets with great potential for deciphering the accurate diagnosis of tumors in addition to predicting prognosis and therapeutic options. Making the correct pathologic diagnosis is always preferred prior to the initiation of treatment of the cancer patient. Current pathologic techniques still find the differential diagnosis of a number of cancers problematic. In fact, the diagnosis of “unknown primary” is applied to nearly 5% of all tumors because the origin of the lesion cannot be identified. Currently, pathologists must apply their “best estimate” of the correct tissue of origin for any given metastatic lesion, based primarily on histological and morphological features and secondarily on semi-quantitative immunohistochemical strains.

The recent development of gene expression profiling technology has permitted the development of prototypical clinical classifiers that demonstrate the feasibility of this molecular approach to diagnosis. Specifically, with the advent of complementary DNA (cDNA) microarrays, gene expression analysis has become an efficient method in the analysis and classification of tumors. The principles of gene expression analysis are disclosed in numerous U.S. patents such as U.S. Pat. Nos. 5,556,752, 5,774,305, 5,837,832, 5,834,655, 5,874,219, 5,849,486 and PCT Patent publications WO 99/27137 and WO 99/10538, all of which are incorporated herein by reference to the extent not inconsistent with the explicit teachings herein.

Precise dissection of gene expression under a particular external influence or point in time can be achieved in a high-throughput, parallel fashion by collecting data using cDNA microarray technology. Microarrays are microscope slides, membranes, or chemically modified silicon surfaces that contain hundreds to tens of thousands of immobilized DNA samples. This array of cDNA spots can be probed with fluorescently labeled cDNA's, which are typically obtained by RT-PCR (reverse transcription-polymerase chain reaction) from total RNA pools corresponding to the test and reference biological sources. Following a hybridization step with two dye-tagged probes corresponding to reference and test cDNA's, the microarray is scanned to generate two images, each one corresponding to one of the dye “colors.” Consequently, the level of intensity at each particular point in each image corresponds to the amount of probe, tagged with the corresponding color dye at that position. The resulting images are subsequently analyzed statistically to reveal patterns and correlations among the hybridization of the many gene probes present.

In the past, statistical clustering methods have been employed to analyze the gene expression data derived from cDNA microarray technology, but these techniques have proved to be inadequate in resolving molecular fingerprints linked to, for example, colon cancer metastasis. Hierarchical clustering, which weights each gene equally, is capable of providing a general separation of tumors into tissue-specific classes, but the equal weighting of all genes rendered this approach incapable of accurately classifying new tumors. Consequently, statistical clustering classifiers are not sufficiently accurate for clinical application where high degrees of accuracy are necessary. The most comprehensive approach to classification published to date involved 14 common tumor types and was only able to achieve a 78% success rate using support vector machines for classification (Ramaswamy, S. & Golub, T. R. DNA Microarrays in Clinical Oncology. J Clin Oncol 20, 1932-41. [2002]). A 78% success rate is not sufficient for clinical accuracy, which requires at least 90% accuracy. Consequently, the promise of this technology has not yet been realized in clinical medicine due to limitations in its scope of application.

Machine learning techniques, such as neural networks, are well known for their pattern recognition and data organization capabilities. Advanced neural learning algorithms exhibit superior accuracy, reliability, and efficiency in many pattern recognition and data mining systems. Neural networks utilize the concept of artificial intelligence (Niederberger, C. S., L. I. Lipshultz, D. J. Lamb Fertil. Steril. 60:324-330; Niederberger, C. S. [1995] J. Urol. 153; Wasserman, P. [1993] Neural Computing Theory and Practice, Van Nostrand Reinhold, New York, pp. 1.1-11; Wasserman, P. [1993] Advanced Methods in Neural Computing, Van Nostrand Reinhold, New York, pp. 1-60; Fu, L. [1994] Neural Networks in Computer Intelligence, McGraw-Hill, Inc., New York, pp. 155-166). Attempts have been made to apply this technology to certain medical problems, including the prediction of myocardial infarction in patients using family history, body weight, lipid profile, smoking status, blood pressure, etc. (Lamb, D. J., C. S. Niederberger [1993] World J. Urol 11: 129-136; Patterson, P. E., [1996] Biomed Sci. Instrum. 32:275-277; Pesonen, E. M. Eskelinen, M. Juhola [1996] Int. J. Biomed Comput. 40:227-233; Ravery, V., L. A. Boccon Gibod, A. Meulemans et al. [1994] Eur. Urol. 26:197-201; Snow, P. B., D. S. Smith, W. J. Catalona [1994] J. Urol. 1923-1926; Stotzka, R., R. Manner, P. H. Bartels, D. Thompson [1995] Anal. Quant. Cytol Histol. 17:204-218; Yoshida, K., T. Izuno, E. Takahashi et al. [1995] Medinfo 1:838-842; Webber, W. R., R. P. Lesser, R. T. Richardson et al. [1996] Electoencephalogr. Clin. Neurophysiol. 98:250-272). Snow and associates also attempted to use a neural network in the detection of prostate cancer and prediction of biochemical failure following radical prostatectomy (Snow et al., supra). While effective to perform classifications on large datasets, the level of diagnosis realized using neural networks alone have not been sufficiently rigorous for use in clinical diagnosis.

Accordingly, there is a need in the art for an informational computation method for classifying objects that exhibits better reliability than currently available methods. Specifically, there is a need for a system, method, and computer-readable media, for classifying tumors that is more accurate, more reliable, and more efficient that is conventionally available.

### BRIEF SUMMARY OF THE INVENTION

The present invention provides an informational computation method for classifying objects. In particular, the invention provides a system, method, and computer readable media for classifying tumors using a nonparametric statistical classifier in conjunction with an artificial neural network. The present invention is a significant improvement over standard methods for analysis of many kinds of data, including analysis of microarray data. The present invention augments and is superior to conventional methods such as clustering and stand-alone neural networks. Thus the present invention overcomes a number of disadvantages inherent in the art related to analysis of large, nonparametric datasets.

The present invention provides a method of using gene expression microarray data to build a clinically relevant, universally applicable tumor classifier. Specifically, the invention uses hybridization patterns generated on available high-density gene discovery microarrays to profile diverse tumor types and develop a molecular expression phenotype that is used to classify tumor types. The invention classifies unknown tumor types based on the correlation of the unknown tumor's genetic expression compared to the genetic expression of known tumor types by first performing a nonparametric statistical analysis on the known data, training an artificial neural network with the known data, and then inputting the unknown tumor data into the neural network

In general, the invention also provides a method for classifying objects based on latent characteristics comprising performing the steps of: a) receiving observation data corresponding to characteristics of known classes of objects; b) identifying latent classes most highly correlated with the characteristics of the known classes of objects; c) selecting, from among the identified latent classes, a set of latent class characteristics that distinguish among the known classes of objects; d) providing said latent class characteristics as input to train a neural network-based classifier; e) training said neural network based classifier to identify unknown objects based on latent class characteristics of the known objects; f) receiving sample data corresponding to characteristics of an unknown object; g) providing the sample data to said trained neural network; and h) calculating the likelihood that the unknown object is a member of each known class of objects based on the correlation between said latent class characteristics of each of the known objects and the characteristics of the unknown object.

In particular, the invention classifies unknown tumors having an unclassified cellular phenotype based on known tumors, having a known cellular phenotype. By providing improved classification of tumors, the invention further provides prediction of survival rates and allows caregivers to determine appropriate courses of treatment based on known effective treatments for the class of characterized tumors. Further, the invention is used to predict the effectiveness of therapies for diseases related to treatable diseases that have known effective therapies based on the correlation of the genetic expression data of the disease to the treatable diseases.

The subject invention further provides a method for creating a genetic expression classifier comprising the steps of a) receiving genetic expression data from a plurality of published microarray data sources; b) normalizing and scaling the received genetic expression data and the generated genetic expression data by: 1) calculating an average gene expression value across a reference RNA sample for each of the published microarray data sources; 2) scaling, gene by gene, the genetic expression data between each of the published microarray data sources; d) statistically screening the scaled published microarray genetic expression data and the generated genetic expression data by performing a non-parametric test to find a subset of genes correlative with the characteristics of interest; e) training and validating an artificial neural network using the statistically screened data; f) inputting sample data into said artificial neural network to determine if the sample data exhibits the characteristics of interest; and g) classifying the sample data based on the sample expression of the characteristics of interest.

The subject invention also includes a computer based system, in addition to the above-described method, for classifying tumors that uses a nonparametric statistical classifier for prescreening data provided to train a neural network and provide tumor classification probabilities based on sample tumor data input into the system. In addition, the invention provides a computer program product comprising computer readable medium for providing a nonparametric statistical classifier to prescreen data provided to train a neural network and predict tumor classification based on sample input data.

Using the teachings provided herein, it is possible to receive genetic expression data, prescreen the data using a nonparametric classifier, construct, train, test, and utilize a neural network for classifying tumors.

Once trained, specific patient tumor data obtained during clinical testing of the patient is input into the neural network to obtain a classification of the patient's tumor. Depending on the type of tumor, a survival rate can be predicted and course of treatment can be determined from a specified output variable. In addition the neural network can be further trained with more data to potentially provide improved classification accuracy.

The objects, features, and advantages of the invention are numerous. One advantage of the invention is that the invention provides better tumor classification than is conventionally possible. The invention will now be described, by way of example and not by way of limitation; with reference to the accompanying sheets of drawings and other objects, features, and advantages of the invention will be apparent from this detailed disclosure and from the appended claims. All patents, patent applications, provisional applications, and publications referred to or cited herein, or from which a claim for benefit of priority has been made, whether supra or infra, are incorporated by reference in their entirety to the extent they are not inconsistent with the explicit teachings of this specification.

### BRIEF DESCRIPTION OF THE DRAWINGS

In order that the manner in which the above recited and other advantages and objects of the invention are obtained, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exemplary representation of an artificial neural network on which the present invention may be implemented.

FIG. 2 is a flow chart illustrating the method steps for classifying objects using a nonparametric preclassifier and an artificial neural network.

FIG. 3 is a flow chart illustrating the method steps for normalizing data and classifying objects using a nonparametric preclassifier and an artificial neural network.

FIG. 4 depicts an exemplary set of histological samples of adenocarcinomas.

FIG. 5 is a graphical representation of the process of data acquisition, normalization and scaling, statistical screening and training a neural network according to the invention.

It should be understood that in certain situations for reasons of computational efficiency or ease of maintenance, the ordering and relationships of the blocks of the illustrated flow charts could be rearranged or re-associated by one skilled in the art. While the present invention will be described with reference to the details of the embodiments of the invention shown in the drawings, these details are not intended to limit the scope of the invention.

### DETAILED DISCLOSURE OF THE INVENTION

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a system, method, and computer readable media to provide better classification of tumors in the clinical environment. Specifically, the invention classifies unknown tumor types based on the correlation of the unknown tumor's genetic expression compared to the genetic expression of known tumor types by first performing a nonparametric statistical analysis on the known data, training an artificial neural network with the known data, and then inputting the unknown tumor data into the neural network.

### I. NEURAL NETWORKS

### Fundamentals of Parallel Processing

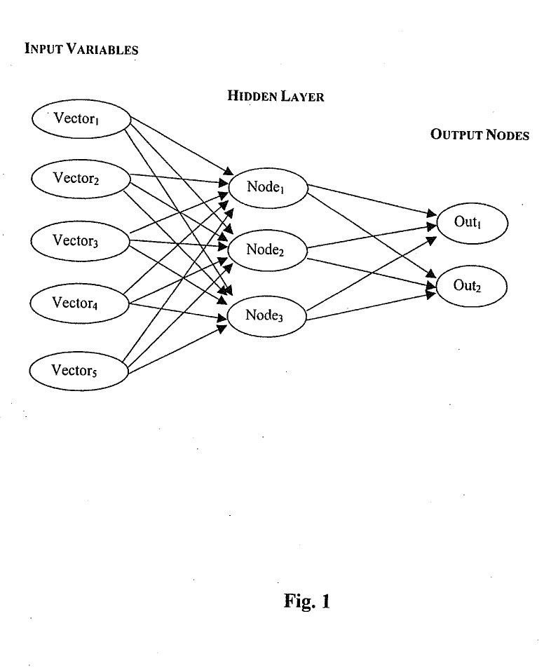

A neural network is typically a computer-based method that is modeled after a large number of simple neuron-like processing elements and a large number of weighted connections between the elements. The weights on the connections encode the knowledge of a network. Despite their diversity, all artificial intelligence neural networks perform essentially the same function—they accept a set of inputs (an input vector) and process it in the intermediate (hidden) layer of processors (neurons) by an operation called vector mapping (FIG. 1). Each neuron in a processor unit receives inputs from one or many neurons of previous layers. The aggregate of these inputs will be processed by the neuron, and input will either be passed on to the next layer or will be aborted. The next layer may be an additional layer of hidden neurons or output neurons. The topology of neuronal connections between various layers of neural network (input, hidden, and output) varies in terms of interconnection schema (feed forward, or recurrent connections). In summary, the output neuron will either fire or not fire depending upon the following factors: number of inputs, weight of inputs, process of inputs in each neuron (activation connectors), and number of hidden layer neurons.

### Network Properties

The topology of a neural network refers to its framework and its interconnection scheme. The framework is often described by the number of layers and number of nodes per layer. According to the interconnection schema, a network can be either feed forward (all connection points in one direction) or recurrent (with feedback connections and loops). The connections can either be symmetrical (equally weighted directional) or asymmetrical. The high-order connection is the one that combines the inputs from more than one node, often by multiplication. The numbers of the inputs determines the order of connection. The order of neural network is the order of the highest order connection. The connection weights can be real numbers or integers. They are adjustable during network training, but some can be fixed deliberately. When training is completed, all of them are fixed.

### Node Properties

The activation levels of nodes can be discrete (e.g., 0 and 1), continuous across a range (e.g., [0,1]), or unrestricted. The activation (transfer) function can be linear, logistic, or sigmoid.

### System Dynamics

The weight initialization scheme is specific to the particular network model chosen. However, in many cases initial weights are just randomized to small numbers. The learning rule is one of the most important attributes to specify for a neural network. The learning rule determines how to adapt connection weight in order to optimize the network performance. It additionally indicates how to calculate the weight adjustments during each training cycle. The inference behavior of a neural network is determined by computation of activation level across the network. The actual activation levels necessary are determined to calculate the errors, which are then used as the basis for weight adjustments.

### Learning

Artificial neural networks learn from experience. The learning methods may broadly be grouped as supervised or unsupervised. Many minor variations of such paradigms exist. Supervised learning: The network is trained on a training set consisting of vector pairs. One vector is applied to the input of the network; the other is used as a “target” representing the desired output. Training is accomplished by adjusting the network weights so as to minimize the difference between the desired and actual network outputs. This process is usually an iterative procedure in which the network output is compared to the largest vectors. This produces an error signal that is then used to modify the network weights. The weight correction may be general (applied to entire network) or specific (to that individual neuron). In either case, the adjustment is in a direction that reduces the error. Vectors from the training set are applied to the network repeatedly until the error is at an acceptably low level. Unsupervised learning (self-organization): It requires only input vectors to train the network. During the training process, the weights are adjusted so that similar inputs produce similar outputs. In this type of network, the training algorithm extracts statistical regularities from the training set, representing them as the value of network weights.

### Generalization

The real-world problems lack consistency; two experiences are seldom identical in every detail. For a neural network to be useful, it must accommodate this variability, producing the correct output despite insignificant deviations between the input and test vector. This ability is called generalization.

### Classification

This is a special case of vector mappings, which has a broad range of applications. Here, the network operates to assign each input vector to a category. A classification is implemented by modifying a general vector mapping network to produce mutually exclusive primary outputs.

### II. PRE-CLASSIFICATION STATISTICAL ANALYSIS

To improve the performance of the neural network, the invention includes a non-parametric statistical preclassifier to prescreen learning data provided to the neural network. Specifically, a Kruskal-Wallis H-test providing non-parametric independent group comparisons is employed to preclassify the input data. The hypotheses for the comparison of two independent groups are: Hₒ (the hypothesis that the samples come from identical populations) and Hₐ (the hypothesis that the samples come from different populations). The hypotheses make no assumptions about the distribution of the populations. These hypotheses are also sometimes written as testing the equality of the central tendency of the populations. The test statistic for the Kruskal-Wallis test is H. This value is compared to a table of critical values for U based on the sample size of each group. If H exceeds the critical value for H at some significance level (usually 0.05) it means that there is evidence to reject the null hypothesis in favor of the alternative hypothesis.

In an embodiment, the Kruskal-Wallis H-test is used to test the null hypothesis that the distribution of gene expression is identical across tumor types relative to the alternative hypothesis that expression distribution differs between types. The test is used to select a set of genes (classification set) that distinguishes each tumor type from the rest, wherein the classification set is the union of the individual gene sets.

### III. OBJECT CLASSIFIER

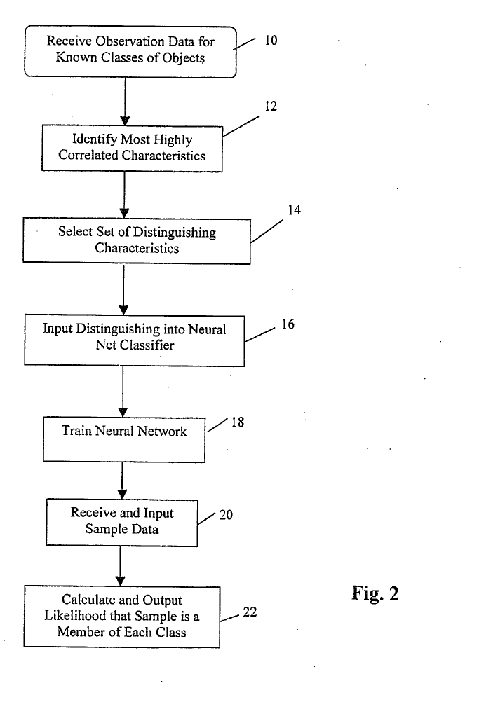

The inventive method for object classification, implementing a combination of the statistical analysis and neural network described above, will now be described. By providing a statistical preclassifier, such as a Kruskal-Wallis H-test to train a neural network, an improved object classifier is implemented according to the invention. Turning now to the flow chart of FIG. 2, a process for classifying objects will now be described. The process begins by receiving observation data 10 corresponding to characteristics of known classes of objects. Next, latent class characteristics most highly correlated with the characteristics of the known classes of objects are identified 12. After the latent class characteristics are identified, a set of latent class characteristics that distinguishes between the known classes of objects is selected from among the identified latent classes 14. After the distinguishing latent class characteristics are selected, the latent class characteristics are input to train a neural network-based classifier 16. The neural network based classifier is then trained 18 to identify unknown objects based on the input latent class characteristics of the known objects. Once the neural network is trained, sample data, corresponding to characteristics of an unknown object, is received and input to the trained network 20. Upon receiving the sample data the neural network calculates and provides the likelihood that the unknown object is a member of each known class of objects 22 based on the correlation between said latent class characteristics of each of the known objects and the characteristics of the unknown object.

In an embodiment, the known object disclosed above is a characterized tumor having a known cellular phenotype, the unknown object is an uncharacterized tumor having an unclassified cellular phenotype, and the characteristics are genetic expressions associated with a cellular phenotype. Correspondingly, the process for classifying unknown tumors according to the invention comprises the same steps as described above, wherein the known object is replaced by a characterized tumor, the unknown object is replaced by an uncharacterized tumor, and the characteristics are replaced by genetic expressions associated with a cellular phenotype. Consequently the process for classifying objects, specifically, tumors comprises: 1) receiving genetic expression data corresponding to the cellular phenotype of a plurality of known tumor type classes; 2) identifying genetic expressions most highly correlated with the cellular phenotype of the known tumor type classes; 3) selecting, from among said highly correlated genetic expressions, a set of tumor cellular phenotype characteristics that distinguish among the cellular phenotypes of each of the tumor type classes; 4) providing said tumor cellular phenotype characteristics as input to train a neural network-based classifier; 5) training said neural network based classifier to identify unknown tumors based on said tumor cellular phenotype characteristics of the known tumor type classes; 6) receiving sample tumor genetic expression data corresponding to a cellular phenotype of an unknown tumor; 7) scaling the sample tumor genetic expression data so that the average sample tumor genetic expression data is equal to the average expression data of the known tumor type classes; 8) providing the scaled sample tumor genetic expression data to said trained neural network; and 9) calculating the likelihood that the unknown tumor is a member of each known class of tumor types based on the correlation between said cellular phenotype characteristics of each of the known tumor type classes and the cellular phenotype characteristics of the unknown tumor.

In a further embodiment of the invention, the process of identifying and classifying tumors further comprises using the output likelihoods that an uncharacterized tumor belongs to a class of characterized tumors to predict survival probabilities based on known survival rates of the class of characterized tumors. For example, if sample genetic expression data derived from a tumor removed from a patient indicates the tumor is a highly aggressive, metastatic tumor that typically is associated with a low survival rate, then the patient's projected survival can be predicted with some certainty. According to the invention, the output likelihoods can also be used to determine a course of treatment based on known effective treatments for the corresponding class of characterized tumors. Further, the likelihood that an uncharacterized object belongs to a class of characterized objects is used to predict the responses to actions performed on the uncharacterized objects based on known responses to actions performed on the characterized objects. For example, if an unknown tumor exhibits a genetic expression that belongs to a known class of tumors, then the actions performed to treat the known class tumor, or medical therapies, can be effectively applied to the classified unknown tumor based on the unknown tumor's membership in the known class. In a further embodiment, the disclosed classifier is used to effectively increase the scope of medical drug trial so that treatments being evaluated for a specific disease, such as a certain type of tumor, can be extrapolated to other diseases, such as tumors having similar genetic expression, genetically classified in the same class as the specific disease under test. For example, Phase I data acquired during clinical trials for a specific disease can be extrapolated to genetically related diseases to provide additional data for potential graduation to a Phase II study.

In another embodiment, the process of receiving known tumor genetic expression data comprises: 1) generating at least one hybridization pattern on a microarray, such as a cDNA array, using at least one known nucleic acid sequence and associated position information derived from at least one known tumor type; 2) hybridizing a universal reference RNA to the microarray; and 3) extracting expression and position information to generate genetic expression data corresponding to the cellular phenotype of each of the tumors used to create a hybridization pattern. In yet another embodiment, the process of receiving known tumor genetic expression data comprises retrieving oligonucleotide microarray profiled genetic expression data from published databases. For example, oligonucleotide microarray profiled genetic expression data can be found on websites or provided on the Internet for easy downloading and input to the invention.

In yet another embodiment for receiving genetic expression data, the process comprises: 1) generating at least one hybridization pattern on a microarray, using at least one known nucleic acid sequence and associated position information derived from at least one known tumor type; 2) hybridizing a universal reference RNA to the microarray; 3) extracting expression and position information to generate genetic expression data corresponding to the cellular phenotype of each of the tumors used to create a hybridization pattern; 4) retrieving oligonucleotide microarray profiled genetic expression data from published databases; and 5) performing normalization of gene expression levels between the retrieved profiled genetic expression data and the generated genetic expression data. Normalization of the gene expression levels further comprises: 1) identifying genes common to the retrieved profiled genetic expression data and the generated genetic expression data; 2) averaging the expression levels for the reference RNA used to generate the generated genetic expression data for each common gene; 3) comparing the averaged expression levels of the generated genetic expression data to the corresponding retrieved profiled genetic expression data for each common gene; 4) calculating a gene specific scaling factor for each common gene; and 5) applying said scaling factor to the profiled genetic expression data.

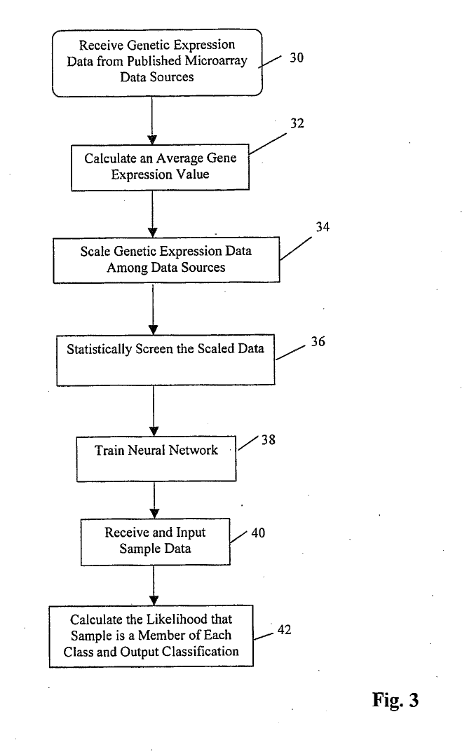

Turning now to the flow chart of FIG. 3, a specific embodiment, wherein genetic expression data is gathered from a variety of sources, is described. The process begins by receiving genetic expression data 30 for a known class of objects derived from published microarray data sources. Next, the process normalizes and scales the received generated genetic expression data by calculating an average gene expression value across a reference RNA sample for each of the published microarray data sources 32 and scaling, gene by gene, the genetic expression data among each of the published microarray data sources 34. Once the genetic expression data is normalized and scaled, the process statistically screens the scaled published microarray genetic expression data 36 by performing a non-parametric test to find a subset of genes correlative with the characteristics of interest. In an embodiment, the nonparametric test is a Kruskal-Wallis H-test for determining the probabilities of class membership based on the hypothesis that the samples come from identical populations and the samples come from different populations. Using the statistically screened data as input, the process trains and validates an artificial neural network 38 to classify genetic expression data based on the input data. After the artificial neural network is trained, the process receives and inputs genetic expression data from a sample 40 into the trained artificial neural network to determine if the sample data exhibits the characteristics of interest and classifies the sample data 42 based on the sample expression of the characteristics of interest.

In another embodiment, the method described above further comprises collecting newly generated genetic expression data from at least one microarray, such as a spotted cDNA microarray, and scaling, gene by gene, the genetic expression data between the scaled genetic expression data of each of the published microarray data sources and the generated genetic expression data. Consequently, as data is derived from different sources and input to train the neural network classifier, better accuracy can be obtained.

In addition to a method of classification, the invention also provides a computer-based system for object classification. The system comprises a computer system running software to perform the data processing steps as described above. The computer system includes a processor and a memory coupled to processor through a bus. The processor fetches computer instructions from memory and executes those instructions. The processor also reads data from and writes data to memory, sends data and control signals through bus to one or more computer output devices, receives data and control signals through bus from one or more computer input devices in accordance with the computer instructions, and transmits and receives data through bus and a network interface to a network.

The memory can include any type of computer memory including, without limitation, random access memory (RAM), read-only memory (ROM), and storage devices that include storage media such as magnetic and/or optical disks. Memory includes a computer process, such as the disclosed steps for classifying objects. A computer process includes a collection of computer instructions and data that collectively define a task performed by computer system.

Computer output devices can include any type of computer output device, such as a printer, a cathode ray tube, or CRT, (alternatively called a monitor or display), a liquid crystal display (LCD), an Electro-luminescent (EL) display, or the like. CRT display preferably displays the graphical and textual information corresponding to the processes running on the processor. Each of computer output devices receives from the processor control signals and data and, in response to such control signals, displays the received data. User input devices can include any type of user input device such as a keyboard, or keypad, or a pointing device, such as an electronic mouse, a trackball, a light pen, a touch-sensitive pad, a digitizing tablet, thumb wheels, or a joystick. Each of user input devices generates signals in response to physical manipulation by a user and transmits those signals through bus to processor. In an embodiment, the computer system is operatively connected to a communications network, such as the Internet, to allow importing and exporting of data to and from other computer systems connected to the network. In addition, the invention includes a computer program product recorded on computer readable medium for classifying objects. The computer readable media contain computer instruction to perform the data processing steps according to the methods of classification as described above.

### IV. EXAMPLES

The following examples and embodiments described below are for illustrative purposes only. Example 1 describes an example of a generating tumor genetic expression data using a spotted cDNA microarray. Example 2 describes a classifier method combining a Kruskal-Wallis H-test prescreened with a neural network using the data generated in Example 1. Example 3 further includes the addition of tumor genetic expression data derived form commercially available microarrays. The examples described herein demonstrate the superiority of the current invention in identifying and classifying objects, in particular, tumors. The current invention is the first which permits identification and classification of tumor types with better than 90% accuracy, a level which meets or exceeds that required for clinical accuracy.

### Example 1

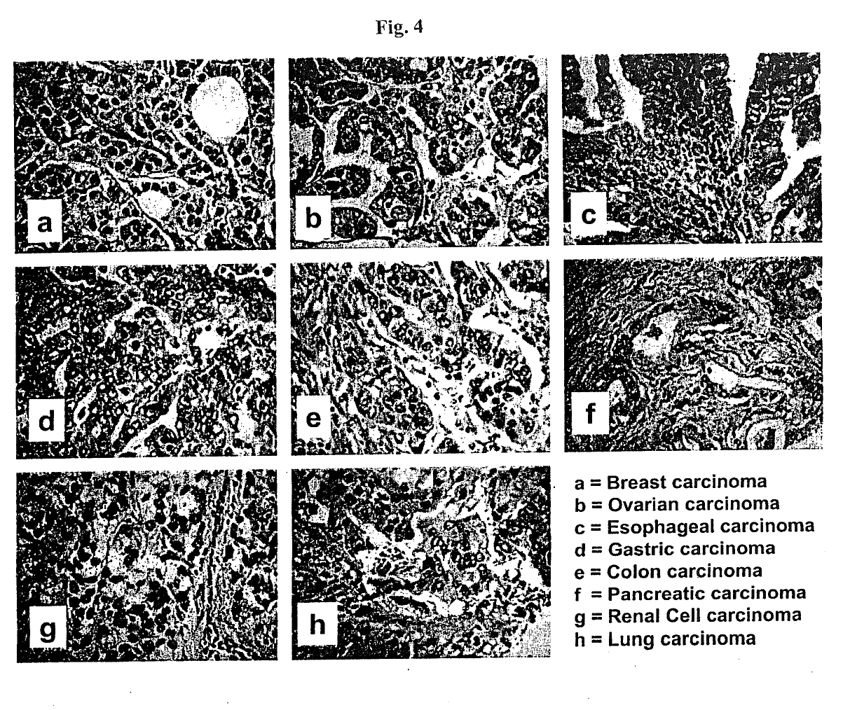

Prior art approaches to tumor classification are limited in predication capability in part because each study selected only a small number of genes sufficient to approximate classification of a restricted set of tumor samples. To evaluate this approach, a spotted cDNA microarray containing 32,448 elements (10 exogenous controls printed 36 times, 3 negative controls printed 6 times, 31872 human cDNAs representing 30849 distinct transcripts—23936 unique TIGR TCs and 6913 ESTs) was used to profile expression in eight different tumor types of similar histological appearance (FIG. 4). Histological classification of tumors is often extremely difficult, as the morphology of the cells is often indistinguishable in tumors from diverse organ sites. Routine histomorphology cannot easily be used to distinguish the sites of origin of the depicted adenocarcinomas (FIG. 4, a-h). Total RNA was prepared from adenocarcinomas (n=10) derived from 8 different sites of origin (breast, pancreas, lung, ovary, kidney, colon, stomach, and esophagogastric junction). The sources of all tumors used in this study are presented in Table 1 below.

TABLE 1
Description of Tumors and Data Sources Used in Classification Analyses.

| | Number of | Array Platform | Website | Reference |
|---|---|---|---|---|
| Tumour Type | Samples | † | ‡ | § |
| Bladder | 19 | U95, HU68 | A, B | 9, β |
| Breast | 42 | U95, HU68, | A, B, F, | 9, β, β |
| | | T32 | | |
| Central-Nervous | 10 | HU68 | C | 1 |
| atypical teratoid/ | | | | |
| rhadboid | | | | |
| Central-Nervous | 10 | HU68 | C | 1 |
| Glioma | | | | |
| Central-Nervous | 70 | HU68 | B, C, | β, 1 |
| Meduloblastoma | | | | |
| Colon | 41 | U95, HU68, | A, B, F | 9, β, β |
| | | T23 | | |
| Stomach/EG | 30 | U95, T32 | A, F | 9, β |
| Junction | | | | |
| Kidney | 31 | U95, HU68, | A, B, F | 9, β, β |
| | | T32 | | |
| Lukemia-Acute | 10 | HY68 | B | β |
| Lymphocyitc | | | | |
| T cell | | | | |
| Lukemia-Acute | 10 | HU68 | B | β |
| Myelogenous | | | | |
| Lung- | 71 | U95, HU68, | A, B, D, E, F | 9, β, 1, α, β |
| Adenocarcinoma | | T32 | | |
| Lung-Squamous | 21 | U95 | A, D, E | 9, 1, α |
| CellCarcinoma | | | | |
| Lymphoma- | 11 | HU68 | B | β |
| Follicular | | | | |
| Lymphoma- | 11 | HU68 | B | β |
| Large B Cell | | | | |
| Melanoma | 10 | HU68 | B | β |
| Mesothelioma | 10 | HU68 | B | |
| Ovary | 44 | U95, HU68, | A, B, F | 9, β, β |
| | | T32 | | |
| Pancreas | 26 | U95, HU68, | A, B, F | 9, β, β |
| | | T32 | | |
| Prostrate | 42 | U95, HU68 | A, B, E | 9, β, α |
| Uterus | 10 | HU68 | B | β |

† Array Legend
U95 = Affymetrix U95A
T32 = 32K TIGR cDNA Array
HU68 = Affymetrix HU6800FL
‡ Data Source URL Legend
A = Bhattacharjee, A. et al. Classification of human lung carcinomas by mRNA expression profiling reveals distinct adenocarcinoma subclasses. Proc Natl Acad Sci USA 98, 13790-5. [2001].
B = Golub, T. R. et al. Molecular classification of cancer: class discovery and class prediction by gene expression monitoring. Science 286, 531-7. [1999].
C = Hedenfalk, I. Et al. Gene-expression profiles in hereditary breast cancer. N Engl J Med 344 539-48. [2001].
D = Pomeroy, S. L. et al. Prediction of central nervous system embryonal tumour outcome based on gene expression. Nature 415, 436-42. (2002).
E = Perou, C. M. et al. Molecular portraits of human breast tumors . Nature 407, 747-52. [2000]
F = Ramaswamy, S. et al. Multicalss cancer diagnosis using tumor gene expression signatures. Proc Nati Acad Sci USA 98, 10869-74. [2001].
§ Publication Legend
In addition to the references to published reports, additional data were provided by:
A = Jove/Bepler, personal communication
B = TIGR

Labeled first-strand cDNA was prepared, and co-hybridized with labeled samples prepared from a universal reference RNA as described in Yang, I. V. et al. Within the Fold: Assessing Differential Expression Measures and Reproducibility in Microarray Assays. Submitted for publication (2002), all hybridizations were replicated with a dye-reversal to eliminate any fluor-specific effects. Data from each hybridization were normalized using local lowess (Yang, I. V. et al. Within the Fold [2002]; Cleveland, W. & Devlin, S. Locally weighted linear regression: an approach to regression analysis by local fitting. J. Am. Stat. Assoc. 83, 596-609 [1988]; and Yang, Y. H. et al., Normalization for cDNA microarray data: a robust composite method addressing single and multiple slide systematic variation. Nucleic Acids Res 30, e15. [2002]). Dye-reversed hybridizations were subjected to replicate flip-dye trimming to eliminate inconsistent data and the geometric mean was calculated for the remaining array elements.

### Example 2

In recognition of the fact that no a priori reason exist to group genes for the purpose of tissue classification, a non-parametric statistical screen was combined with an artificial neutral network (Khan, J. et al. Classification and diagnostic prediction of cancers using gene expression profiling and artificial neural networks (ANN). Nat Med 7, 673-9. [2001]) to assign weights to individual genes that could then be used for classification. An artificial ANN is versatile algebraic construct that can approximate almost any nonlinear relationship. It is an ideal tool to apply to classification problems associated with complex microarray datasets because it requires no predetermined assumptions about the relative importance of any particular gene in the classification. However, before the ANN can be used for classification, it must first be trained to perform this function. Training uses input gene expression vectors that are paired with target vectors representing tumors with defined histological classifications to determine the appropriate weights for each gene. These weights are used in an estimate of whether the gene expression levels are indicative of a particular tumour type.

Using approximately 75% of the tumors in Table 1, a non-parametric Kruskal-Wallis H-test was used to first identify a set of genes most-highly correlated with tumour histological classification. An initial classification set of 685 genes was identified. These genes and their expression vectors were then used to train an ANN to identify specific tumour types. By training the classifier using a set of 153 tumour samples, an ANN was developed that was able to correctly classify 95% of tumors from a test set of 32 tumour samples representing the eight tissues of origin. Only 1 breast and 1 stomach tumour were misclassified. Notably, the disclosed classification method results were superior to other published tumour classifiers. Rather than using a relatively small subset of genes to distinguish a small number of related tumour types, the disclosed preclassifier/ANN combination uses a large number of genes in a weighted approach to separate both closely related and distinct tumour types.

### Example 3

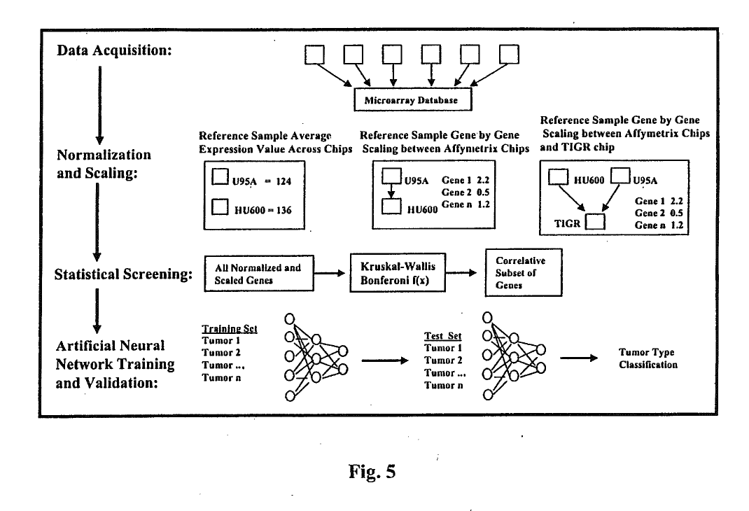

Based on the positive results of the classification method used in Example 2, the method was extended to develop a more general, clinically applicable and robust classifier. The approach used is summarized in FIG. 5, depicting the process of classification in four stages: data acquisition, normalization and scaling, statistical screening and training a neural network. Data Acquisition involves a literature search for suitable published microarray data and the collection of this and newly generated data into a microarray database. Normalization and Scaling comprises calculation of an average gene expression value across a reference sample for two Affymetrix™ chip types, gene by gene scaling between Affymetrix™ chip types and the gene by gene scaling between Affymetrix™ chip types and the spotted microarray. A non-parametric statistical screening is used to find a subset of genes correlative with tumor type. This set of genes is then used to train and validate an artificial neural network.

In accordance with the above steps, available literature was searched for gene expression studies and a collection of 466 tumors, which had been profiled on Affymetrix GeneChips™, representing 21 tumour types, accounting for over 95% of all human tumors was identified. Only datasets that included at least ten independent measurements for each tumour type were chosen, as fewer in any single group reduced the accuracy of training the ANN. Only studies using Affymetrix GeneChip™ arrays rather than spotted cDNA arrays were selected because the instant classification approach relies on using expression having a fixed reference RNA source to normalize and scale gene expression patterns across samples on a gene-by-gene basis and each spotted array study used its own unique reference RNA sample. The characteristics of the tumour samples analyzed by Affymetrix HFL6800™ and U95A GeneChips™ are summarized in Table 1. In order to provide ratiometric measures of gene expression, the same GeneChips™ were used to profile the same RNA sample used as a reference in the spotted array assays described in Example 1.

The data derived from the Affymetrix HFL6800™ and U95A GeneChips™ were combined with the expression data generated from the spotted arrays to develop a universal classifier. A set of 2252 genes common to all microarrays under consideration was selected using RESOURCERER 4.0™ (Tsai J., Sultana R., Lee Y., Pertea G., Karamycheva S., Antonescu V., Cho J., Parvizi B., Cheung F., Quackenbush J., [2001], “RESOURCERER: a Database for Annotating and Linking Microarray Resources Within and Across Species”, Genome Biology, 2[11]:software0002.1-0002.4) and the genes most highly correlated with particular histological classifications were selected. Four hundred expression measures representing the available experimental datasets were selected to represent all available array platforms and tumour types. The expression vectors corresponding to the common subset of genes were used to train an ANN and the resulting tumour classifier was applied to the remaining 140 expression data samples. The trained ANN was able to correctly classify nearly 86% of the 140 tumors from the blinded test set. This classification rate is superior to the best available classifier described previously for a complex tumour dataset, in both percentage of tumors correctly classified and number of tumour types queried (n=21).

To improve the accuracy of the classifier, two factors were addressed in subsequent experiments: 1) the cross-platform scaling and normalization procedure; and (2) the reduction of the available classification gene set due to cross-platform gene linking. Consequently, an independent, single-platform classifier using a large set of tumors (n=466) assessed by Affymetrix GeneChips™ was used to improve the accuracy of the classifier. For application to the Affymetrix HFL6800™ platform, the reference RNA source was labeled and hybridized to the HU6800 and U95A GeneChips™ and the expression for each gene (a total of 6800 genes common to each chip) was measured. For each tumour sample, the measured expression level for each gene on the array was scaled so that its average measured expression was equal to the average measured for our reference sample. For each gene in common, expression levels for the reference RNA sample on the spotted arrays was averaged and compared to expression measured for the reference RNA applied to the appropriate Affymetrix GeneChip™ to calculate a gene-specific scaling factor. This scaling factor was used to adjust the remaining data (GeneChip™) to make it comparable to the spotted arrays. The measured values for the values measured for the tumour arrays to scale the data to make it comparable to the spotted arrays. Whenever multiple representatives of a single gene were represented on array, their values were averaged. Resealed expression values were chosen instead of ratios because neural networks perform best when the input data have as wide a range as possible.

The Kruskal-Wallis H-test was again applied to a randomly selected set of 316 arrays to select 2170 genes that were used to train the ANN using the intra-platform (Affymetrix), cross-chip, scaled and normalized values By applying this trained ANN to the remaining 120 tumour samples, we were able to correctly predict the known pathology of 93% of the samples. An error rate of 7% is acceptable when compared with the probable rate of error in routing pathologic diagnosis (Nakhleh, R. E. & Zarbo, R. J. Amended reports in surgical pathology and implications for diagnostic error detection and avoidance: a College of American Pathologists Q-probes study of 1,667,547 accessioned cases in 359 laboratories. Arch Pathol Lab Med 122, 303-9. [1998]; Zarbo, R. J. Monitoring anatomic pathology practice through quality assurance measures. Clin Lab Med 19, 713-42, v. [1999]). These errors were distributed relatively evenly across multiple tissue classes (see Table 2 below).

TABLE 2
Performance of the Affymetrix Classifier
across 21 Tumour Types.

| | Classification |
|---|---|
| Tumour Type | Success Rate |
| Bladder | 4/4 |
| Breast | 7/8 |
| Central-Nervous | 3/3 |
| AT/RT | |
| Central-Nervous | 17/17 |
| Meduloblastoma | |
| Colon | 8/8 |
| Stomach/EG Junction | 3/3 |
| Kidney | 5/5 |
| Lukemia Acute | 3/3 |
| Lymphocyitc B Cell | |
| Lukemia Acute | 3/3 |
| Lymphocyitc T cell | |
| Lukemia, Acute | 3/3 |
| Myelogenous | |
| Lung Adenocarcinoma | 13/15 |
| Lymphoma, Follicular | 2/3 |
| Lymphoma Large B | 3/3 |
| Cell | |
| Melanoma | 3/3 |
| Mesothelioma | 3/3 |
| Ovary | 7/9 |
| Pancreas | 3/4 |
| Prostrate | 10/11 |
| Uterus | 3/3 |

It has been previously reported that metastatic lesions and poorly differentiated lesions may be difficult to classify because these lesions have lost some of the expression of their differentiating genes (Su, A. I. et al. Molecular classification of human carcinomas by use of gene expression signatures. Cancer Res 61, 7388-93. [2001]). When the GeneChip™ oligonucleotide-based algorithm was applied to 19 metastatic lesions for which the primary tumour origin had been identified, 16 (84%) were correctly classified. An evaluation of a smaller set of poorly differentiated lesions produced similar results.

### V. SUMMARY

Accordingly, it has been demonstrated in the foregoing portions of this specification that the disclosed method provides superior object classification by combining a statistical preclassifier with a neural network. Specifically, by using a variety of tumor genetic expression data sets, including both published data sets and generated data sets, a tumor classifier, robust and accurate enough for clinical application, is provided.

The application of gene expression profiling signals a significant paradigm shift in medicine toward chip-based diagnosis, prognosis and therapy, in which patients' tumors can be profiled and the most appropriate and efficacious therapeutic regimen applied. Advantageously, rather than focusing on a small number of genes, the disclose method uses whole-genome expression profiles representing the comprehensive molecular expression fingerprints of each tumour to achieve superior classifier results. The molecular expression fingerprints can then be used to create increasingly accurate and comprehensive classifiers. In addition to tumor classification based on the genetic expression of biopsied tumors tissue removed from the patient, the disclosed method can also be adapted to classify tumors based on fine needle aspirates and other minimally invasive biopsy techniques now in common clinical use.

The inventive method can also be embodied as computer readable code on a computer readable medium. The computer readable medium is any data storage device that can store data that thereafter can be read by a computer system. Examples of computer readable medium include read-only memory, random-access memory, CD-ROMs, magnetic tape, optical data storage devices. The computer readable medium can also be distributed over network coupled computer systems so that the computer readable code is stored and executed in a distributed fashion.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention as set forth in the claims.

User input may be received from the keyboard, mouse, pen, voice, touch screen, or any other means by which a human can input data to a computer, including through other programs such as application programs.

One skilled in the art of computer science will easily be able to combine the software created as described with appropriate general purpose or special purpose computer hardware to create a computer system or computer sub-system embodying the method of the invention.

It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A method for classifying at least one tumor based on the tumor's gene expression profile comprising:
a) receiving observation data corresponding to gene expression characteristics of at least one known class of tumors;
b) applying a Kruskal-Wallis H-test to identify at least one latent class most highly correlated with the gene expression characteristics of the at least one known class of tumors;
c) selecting, from among the at least one identified latent classes, a set of gene expression characteristics that distinguish among the at least one known class of tumors;
d) providing said gene expression characteristics as input to a computer-based system to train a supervised artificial neural network-based classifier;
e) training said supervised artificial neural network-based classifier to identify tumors of unknown class based on said gene expression characteristics of the at least one known class of tumors to provide a trained artificial neural network residing in the computer-based system;
f) receiving sample data corresponding to characteristics of a tumor of unknown class;
g) providing the sample data as input to said trained artificial neural network of the computer-based system;
h) calculating the likelihood that the tumor of unknown class for which sample data was received is a member of each known class of tumors based on the correlation between said gene expression characteristics of each of the known class of tumors and the gene expression characteristics of the tumor of unknown class; and
i) outputting the likelihood to a user;
wherein said artificial neural network is a supervised artificial neural network.

2. The method of claim 1, further comprising predicting survival probabilities based on the likelihood that an uncharacterized tumor belongs to a class of characterized tumors and based on known survival rates of the class of characterized tumors.

3. The method of claim 1, further comprising determining a course of treatment based on the likelihood that an uncharacterized tumor belongs to a class of characterized tumors and based on known effective treatments for the class of characterized tumors.

4. The method of claim 1, further comprising predicting responses to actions performed on the uncharacterized tumor based on the likelihood that an uncharacterized tumor belongs to a class of characterized tumors and based on known responses to actions performed on the characterized tumors.

5. The method of claim 4, wherein the actions performed on the uncharacterized tumors and characterized tumors are medical therapies to treat the tumors.

6. The method of claim 5, wherein the medical therapies are drug trials.

7. A method of classifying at least one tumor based on the tumor's cellular phenotype comprising:
a) receiving genetic expression data corresponding to the cellular phenotype of a plurality of known tumor type classes;
b) applying a Kruskal-Wallis H-test to identify genetic expressions most highly correlated with the cellular phenotype of the known tumor type classes;
c) selecting, from among said highly correlated genetic expressions, a set of tumor cellular phenotype characteristics that distinguish among the cellular phenotypes of each of the tumor type classes;
d) providing said tumor cellular phenotype characteristics as input to a computer-based system to train a supervised artificial neural network-based classifier;
e) training said supervised artificial neural network-based classifier to identify tumors of unknown class based on said tumor cellular phenotype characteristics of the known tumor type classes to provide a trained artificial neural network residing on the computer-based system;
f) receiving sample tumor genetic expression data corresponding to a cellular phenotype of a tumor of unknown class;
g) scaling the sample tumor genetic expression data so that the average sample tumor genetic expression data is equal to the average expression data of the known tumor type classes;
h) providing the scaled sample tumor genetic expression data as input to said trained artificial neural network of the computer-based system;
i) calculating the likelihood that the tumor of unknown class is a member of each known class of tumor types based on the correlation between said cellular phenotype characteristics of each of the known tumor type classes and the cellular phenotype characteristics of the tumor of unknown class; and
j) outputting the likelihood to a user;
wherein said artificial neural network is a supervised artificial neural network.

8. The method of claim 7, wherein receiving known tumor genetic expression data comprises:
a) generating at least one hybridization pattern on a microarray, using at least one known nucleic acid sequence and associated position information derived from at least one known tumor type;
b) hybridizing a universal reference RNA to the microarray; and
c) extracting expression and position information to generate genetic expression data corresponding to the cellular phenotype of each of the tumors used to create a hybridization pattern.

9. The method of claim 7, wherein receiving known tumor genetic expression data comprises retrieving oligonucleotide microarray profiled genetic expression data from published databases.

10. The method of claim 7, wherein receiving genetic expression data of step (a) comprises:
a) generating at least one hybridization pattern on a microarray, using at least one known nucleic acid sequence and associated position information derived from at least one known tumor type;
b) hybridizing a universal reference RNA to the microarray;
c) extracting expression and position information to generate genetic expression data corresponding to the cellular phenotype of each of the tumors used to create a hybridization pattern;
d) retrieving oligonucleotide microarray profiled genetic expression data from published data sources; and
e) performing normalization of gene expression levels between the retrieved profiled genetic expression data and the generated genetic expression data.

11. The method of claim 10, wherein normalization further comprises:
a) identifying genes common to the retrieved profiled genetic expression data and the generated genetic expression data;
b) averaging the expression levels for the reference RNA used to generate the generated genetic expression data for each common gene;
c) comparing the averaged expression levels of the generated genetic expression data to the corresponding retrieved profiled genetic expression data for each common gene;
d) calculating a gene specific scaling factor for each common gene; and
e) applying said scaling factor to the profiled genetic expression data.

12. A computer based system for classifying at least one tumor based on the tumor's latent characteristics comprising:
a) at least one computing device comprising a display, a central processing unit (CPU), operating system software, memory for storing data, a user interface, and input/output capability for reading and writing data; and
b) computer code, running on said computing device, for:
1) receiving observation data corresponding to characteristics of at least one known class of tumors;
2) identifying latent classes most highly correlated with the characteristics of the at least one known class of tumors using a Kruskal-Wallis H-test;
3) selecting, from among the identified latent classes, a set of latent class characteristics that distinguish among the at least one known class of tumors;
4) providing said latent class characteristics as input to train a supervised artificial neural network-based classifier;
5) training said supervised artificial neural network based classifier to identify tumors of unknown class based on latent class characteristics of the at least one known class of tumors to provide a trained artificial neural network;
6) receiving sample data corresponding to characteristics of a tumor of unknown class;
7) providing the sample data to said trained artificial neural network; and
8) calculating the likelihood that the tumor of unknown class is a member of each known class of tumors based on the correlation between said latent class characteristics of each of the known class of tumors and the characteristics of the tumor of unknown class;
wherein said artificial neural network is a supervised artificial neural network.

13. The computer based system of claim 12, wherein said computing device is operably connected to a communications network.

14. A computer based system for classifying at least one tumor based on the tumor's cellular phenotype comprising:
a) at least one computing device comprising a display, a central processing unit (CPU), operating system software, memory for storing data, a user interface, and input/output capability for reading and writing data; and
b) computer code, running on said computing device, for:
1) receiving genetic expression data corresponding to the cellular phenotype of a plurality of known tumor type classes;
2) identifying genetic expressions most highly correlated with the cellular phenotype of the known tumor type classes;
3) selecting, from among said highly correlated genetic expressions, a set of tumor cellular phenotype characteristics that distinguish among the cellular phenotypes of each of the tumor type classes;
4) providing said tumor cellular phenotype characteristics as input to train a supervised artificial neural network-based classifier;
5) training said supervised artificial neural network-based classifier to identify tumors of unknown class based on said tumor cellular phenotype characteristics of the known tumor type classes to provide a trained artificial neural network;
6) receiving sample tumor genetic expression data corresponding to a cellular phenotype of a tumor of unknown class;
7) scaling the sample tumor genetic expression data so that the average sample tumor genetic expression data is equal to the average expression data of the known tumor type classes;
8) providing the scaled sample tumor genetic expression data to said trained artificial neural network; and
9) calculating the likelihood that the tumor of unknown class is a member of each known class of tumor types based on the correlation between said cellular phenotype characteristics of each of the known tumor type classes and the cellular phenotype characteristics of the tumor of unknown class;
wherein said artificial neural network is a supervised artificial neural network.

15. A computer program product comprising a computer usable storage medium having computer readable program code embodied therein for classifying at least one tumor based on the tumor's latent characteristics, wherein the computer readable program code in said computer program product causes a computer to effect the steps of:
a) receiving observation data corresponding to characteristics of at least one known class of tumors;
b) identifying latent classes most highly correlated with the characteristics of the at least one known class of tumors using a Kruskal-Wallis H-test;
c) selecting, from among the identified latent classes, a set of latent class characteristics that distinguish among the at least one known class of tumors;
d) providing said latent class characteristics as input to train a supervised artificial neural network-based classifier;
e) training said supervised artificial neural network-based classifier to identify tumors of unknown class based on latent class characteristics of the at least one known class of tumors to provide a trained artificial neural network;
f) receiving sample data corresponding to characteristics of a tumor of unknown class;
g) providing the sample data to said trained artificial neural network; and
h) calculating the likelihood that the tumor of unknown class is a member of each known class of tumors based on the correlation between said latent class characteristics of each of the known class of tumors and the characteristics of the tumor of known class;
wherein said artificial neural network is a supervised artificial neural network.

16. A computer program product comprising a computer usable storage medium having computer readable program code embodied therein for classifying at least one tumor based on the tumor's cellular phenotype, wherein the computer readable program code in said computer program product causes a computer to effect the steps of:
a) receiving genetic expression data corresponding to the cellular phenotype of a plurality of known tumor type classes;
b) identifying genetic expressions most highly correlated with the cellular phenotype of the known tumor type classes using a Kruskal-Wallis H-test;
c) selecting, from among said highly correlated genetic expressions, a set of tumor cellular phenotype characteristics that distinguish among the cellular phenotypes of each of the tumor type classes;
d) providing said tumor cellular phenotype characteristics as input to train a supervised artificial neural network-based classifier;
e) training said supervised artificial neural network based classifier to identify tumors of unknown class based on said tumor cellular phenotype characteristics of the known tumor type classes to provide a trained artificial neural network;
f) receiving sample tumor genetic expression data corresponding to a cellular phenotype of a tumor of unknown class;
g) scaling the sample tumor genetic expression data so that the average sample tumor genetic expression data is equal to the average expression data of the known tumor type classes;
h) providing the scaled sample tumor genetic expression data to said trained artificial neural network; and
i) calculating the likelihood that the tumor of unknown class is a member of each known class of tumor types based on the correlation between said cellular phenotype characteristics of each of the known tumor type classes and the cellular phenotype characteristics of the tumor of unknown class;
wherein said artificial neural network is a supervised artificial neural network.

17. The computer program product of claim 16, wherein receiving genetic expression data of step (a) comprises:
i) generating at least one hybridization pattern on a microarray, using at least one known nucleic acid sequence and associated position information derived from at least one known tumor type;
ii) hybridizing a universal reference RNA to the microarray;
iii) extracting expression and position information to generate genetic expression data corresponding to the cellular phenotype of each of the tumors used to create a hybridization pattern;
iv) retrieving oligonucleotide microarray profiled genetic expression data from published data sources; and
v) performing normalization of gene expression levels between the retrieved profiled genetic expression data and the generated genetic expression data.

18. The computer program product of claim 17, wherein the computer readable program code in the computer program product causes the computer to further effect the steps of:
a) identifying genes common to the retrieved profiled genetic expression data and the generated genetic expression data;
b) averaging the expression levels for the reference RNA used to generate the generated genetic expression data for each common gene;
c) comparing the averaged expression levels of the generated genetic expression data to the corresponding retrieved profiled genetic expression data for each common gene;
d) calculating a gene specific scaling factor for each common gene; and
e) applying said scaling factor to the profiled genetic expression data.

19. The computer based system of claim 14, wherein receiving genetic expression data of step (1) comprises:
i) generating at least one hybridization pattern on a microarray, using at least one known nucleic acid sequence and associated position information derived from at least one known tumor type;
ii) hybridizing a universal reference RNA to the microarray;
iii) extracting expression and position information to generate genetic expression data corresponding to the cellular phenotype of each of the tumors used to create a hybridization pattern;
iv) retrieving oligonucleotide microarray profiled genetic expression data from published data sources; and
v) performing normalization of gene expression levels between the retrieved profiled genetic expression data and the generated genetic expression data.

20. The method of claim 1, wherein said outputting comprises displaying the likelihood on one or more computer output devices of the computer-based system.

21. The method of claim 20, wherein the one or more computer output devices is selected from the group consisting of a printer, cathode ray tube, liquid crystal display, and electro-luminescent display.
